(19) United States
(12) Patent Application Publication
(10) Pub. No.: US 2017/0300272 A1
(43) Pub. Date: Oct. 19, 2017

(54) PRINT JOB PROCESSING SYSTEM WITH PARTIAL MEDIA AND A METHOD THEREFOR

(71) Applicant: Océ-Technologies B.V., Venlo (NL)

(72) Inventors: Vijay A. KALLOE, Venlo (NL); Paul A.H. DEKKERS, Venlo (NL); Josephus A.M. VAN DUN, Venlo (NL)

(73) Assignee: Océ-Technologies B.V., Venlo (NL)

(21) Appl. No.: 15/636,981

(22) Filed: Jun. 29, 2017

Related U.S. Application Data
(63) Continuation of application No. PCT/EP2015/081396, filed on Dec. 30, 2015.

(30) Foreign Application Priority Data
Jan. 6, 2015 (EP) 15150169.9

(51) Int. Cl. G06F 3/12

(52) U.S. Cl. CPC G06F 3/1204; G06F 3/1285; G06F 3/1255; G06F 3/1256

(57) ABSTRACT

A print job processing system includes a printer; a user interface; a job file receiving section; and a media management system adapted to extract media specifications from a received job file and check the media specifications for compatibility with properties and/or a current status of the printer. The media management system is adapted to check whether essential media specifications are defined in the job file or not and, when they are not defined, to invite the user via the user interface to complete the specifications.

### TECHNICAL FIELD OF THE INVENTION

The present invention relates to a print job processing system comprising:
a printer;
a user interface;
a job file receiving section; and
a media management system adapted to extract media specifications from a received job file and to check the media specifications for compatibility with properties and/or a current status of the printer.

### BACKGROUND OF THE INVENTION

An example of a known print job processing system has been described in U.S. 2012/0287646 A1.

When a print job is to be printed with a digital printer, the print data are encoded in an electronic file, the job file, which typically is set up in a page description language (PDL) in a specific format such as Postscript™, PDF or the like. The job file may include image content of different types such as text, vector graphics, photographs or bitmap data and will also include certain meta data that specify the job settings including, among others, the media specifications that indicate the required properties of the print media, such as the format, the paper quality, color, surface coating and the like.

In general, a print engine of a digital printer is only capable of processing print data that are presented in the form of bitmap data, i.e. data specifying a density and/or color value for each individual pixel of each page to be printed. Thus, the image data included in the job file have to be converted into the bitmap format by means of a process that is called raster image processing (RIP). A raster image processor will accordingly interpret the text, vector graphics and other image contents for each page of the job file and will convert them into page-size bitmaps. Further, the raster image processor has the task to extract the media specifications and other meta data from the job file and to forward them to the print engine.

It is convenient that the meta data are displayed on a user interface, either locally at the printer or at a remote workstation that is connected to the print job processing system via a network. Thus, the user will have the opportunity to check the settings before the print process is actually started.

In some cases, the media specifications that have been extracted by the raster image processor may specify media properties that are in conflict with the physical properties and capabilities of the printer or require resources that are presently not available at the printer. In such cases, the user is alerted of the conflict via the user interface so that he has the possibility to change the media specifications or make sure that the required media will be supplied.

On the other hand, the media specifications in the job file may be incomplete or may be missing at all. In such cases, it is common practise that the media management system automatically inserts pre-defined default settings.

### SUMMARY OF THE INVENTION

It is an object of the present invention to provide a print job processing system and method that reduce the risks of degraded print quality and malfunctions of the printer.

According to the present invention, the media management system is adapted to check whether essential media specifications are defined in the job file or not and, when they are not defined, to invite the user via the user interface to complete the specifications.

There are several reasons why the media specifications in a job file may be incomplete.

For example, it is common practice that the detailed media specifications are indicated in a catalogue that is stored in the media management system or to which the management system has access via a network. Then, it is sufficient that the job file includes a unique identifier that designates the media to be used, and the detailed media specifications will automatically be retrieved from the catalogue. However, when the user who compiles the job file wishes to designate a media type that is not (yet) found in the catalogue, he may choose an option “Define custom media” and enter the parameters of the media as far as they are available, e.g. the name, type, size, weight, and color of the media, a designation whether the media sheet is a tab or an insert, the cycle length, the number of punch holes, and the like. When the job is submitted to the printer, the media management system recognizes that the media do not occur in the catalogue and treats them as “temporary media”. In that situation, the parameters that have been available to the user may be incomplete and may lack important information that is needed for performing the print job under optimal conditions.

Important examples of such relevant information are the media family and the surface type.

The media family is linked to color output profiles that are required for RIP with the correct colors. The background is that the color and the physical properties of the media sheet itself have an impact on the color output profile, i.e. on the composition of basic colors (e.g. CMYK) that need to be deposited on the sheet in order to reproduce the desired color impression. Thus, when the media family is not well defined and a default setting is used instead, the resulting print quality may be sub-optimal.

The surface type may specify, for example, whether the media sheet is coated on one side or on both sides or not at all and, when it is coated, what are the material and/or physical properties of the coating. These parameters determine how the media sheet will react on the processing steps in the printer, in particular how it will react to heating in a fuse station or ink curing station of the printer. If these parameters are not correct, the result may not only be a degraded print quality but also damage or increased wear or unnecessarily high power consumption, etc. of the printer.

Another example of an important media parameter is the thickness of the media sheet and/or the tendency of the sheet to swell when exposed to heat and/or humidity. For example, in high quality ink jet printers, the print heads may be arranged to form only a very small gap with the media surface during printing. Then, when an incorrect value has been assumed for the sheet thickness, the print heads may collide with the sheet, causing serious damage to the printer.

Another reason why media specifications in the job file may be incomplete results from the practice to import and export media specifications between catalogues that have been established for different printing systems. The physical properties of the printing systems may be such that certain media parameters are irrelevant in one system, and are therefore not included in the catalogue, but are relevant in another printing system. For example, the above-mentioned media family that is linked to the color output profile is not relevant in a black-and-white printing system. Then, when the media specifications are imported from the catalogue of the black-and-white printing system to the catalogue of a color printing system, the parameter “media family” will be missing.

In all these situations, the present invention assures that the user is at least alerted of the fact that the definition of the media parameters is incomplete, so that the user has the possibility to supplement the media specifications or to abort the print job.

The alert on incomplete parameter definitions according to the present invention should not be confused with the known concept of an alert on conflict. When the definitions of media parameters are incomplete, this does not necessarily mean that there is actually a conflict, at least not a conflict that would be predictable for the system, because it is still possible to use default settings that, of course, have been selected so as to avoid conflict. Thus, normally, the printer would still be operative and the only consequence would be a non-optimal print quality and/or an increased risk of malfunction.

More specific optional features of the present invention are indicated in the dependent claims.

Preferably, when the user is alerted of incomplete media specifications, he will still have the option to confirm the default settings, so that the print job may be processed, though with the risk of degraded quality.

When print jobs with a large volume, e.g. a large number of pages, are processed in a high production printing system, it is common practice that the first pages of the job are printed already while the RIP is still busy with ripping the subsequent pages. Then, when different media are to be used for the subsequent pages, the RIP may detect undefined media parameters only at a time when the print process is running already. In that case, the print process is preferably put on hold until the user has changed or confirmed the media specifications. If the specifications are changed, it may be necessary to repeat the RIP process for at least some of the pages.

In another embodiment, the job file receiving section and the media management system may be arranged such that it is possible to extract the media specifications from the job file in advance, i.e. before the time-consuming conversions in the RIP process are started. In that case, the user may be alerted of incomplete definitions already at an early stage in the process flow, so that the entire job can be processed more efficiently.

If the print job processing system comprises a plurality of printers with different properties, then, when an incomplete media specification is found, the user may also be given the option to re-direct the print process to another printer which is less sensitive to the missing parameters.

### BRIEF DESCRIPTION OF THE DRAWINGS

Embodiment examples will now be described in conjunction with the drawings, wherein:

FIG. 1 is a block diagram of a print job processing system according to the present invention;

FIG. 2 is a flow diagram illustrating a method according to an embodiment of the present invention;

FIG. 3 is a flow diagram illustrating a method according to a modified embodiment of the present invention; and

FIGS. 4 to 7 are examples of display screens to be displayed on a user interface of the system according to the present invention.

### DETAILED DESCRIPTION OF THE EMBODIMENTS

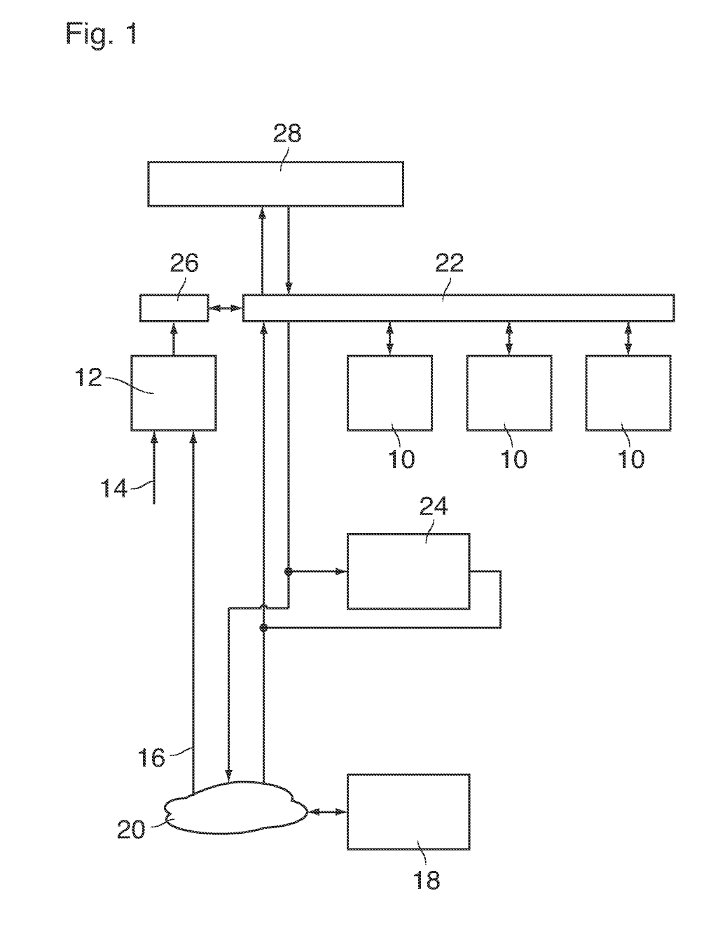

In FIG. 1, a print job processing system comprising a plurality of printers 10 has been shown in the form of a block diagram.

A receiving section 12 is provided for receiving print job files either via a local input port 14 such as a USB socket for plugging-in a memory stick or the like, or via a network port 16 connecting the print job processing system to a remote workstation 18 of a user via a network 20 such as a LAN, the Internet, or the like.

A scheduler 22 is provided for scheduling a plurality of print jobs that are received via the receiving section 12 for processing in the printers 10. For example, the scheduler may at least preliminarily arrange the print jobs in a print queue in the order in which they are received by the receiving section 12. The scheduler 22 communicates with a local user interface 24 which, as usual, may comprise a display screen and input and command keys on an operating panel of the printer. In the example shown, the scheduler may also communicate via the network 20 with the workstation 18 which will serve as another (remote) user interface.

Immediately upon receipt of a job file, the receiving section 12 forwards this job file to a job file interpreter 26 where meta data that specify the job settings are extracted from the job file. The job settings are displayed on the user interface 24 and/or the workstation 18 so that they may be checked by the user. Among others, these job settings include media specifications that identify the media to be used for printing the pages of the job and specify relevant parameters of these media either explicitly or implicitly by referring to a media catalogue.

A media management system 28 communicates with the scheduler 22 and checks the media specifications, as extracted by the job file interpreter 26, against the physical properties and current status of the printers 10. If there is any conflict that cannot be resolved by re-directing the print job to another printer (e.g. a printer in which the required media are loaded already), the user will be alerted of this fact via the user interface.

Moreover, as will be described in greater detail below, the media management system 28 checks whether the media specifications in a job file are complete in the sense that they define all media parameters that are relevant for processing the print job in the printer 10 that has been selected by the scheduler 22. In this process, the media management system 28 will also refer to the data in the media catalogue that is either stored locally or to which the management system has access via the network 20. If the media specifications for a given job file are found to be incomplete, the user is again alerted by a corresponding message on the user interface.

In the example shown, it shall be assumed that each printer 10 has its own raster image processor (RIP) for converting the image data in the job file that has been assigned to that printer into bitmap data. While the conversion of image data into bitmap data in the RIP normally takes a considerable time, depending upon the size of the job, the extraction of the meta data in the job file interpreter 26 is a relatively quick process, so that the meta data are available at the user interface(s) practically immediately after the job file has been received by the receiving section. Thus, the user gets immediate feedback and does not have to wait until the rather time-consuming conversion process in the RIP has been completed. Moreover, the raster image processing may be started immediately, so that the RIP is operating already while the user is still checking the job settings (as specified by the meta data) at the user interface 24 and is still considering whether the settings are correct or need to be changed. Thus, at least in the case that the settings turn out to be correct, the total time required for handling the job is shortened.

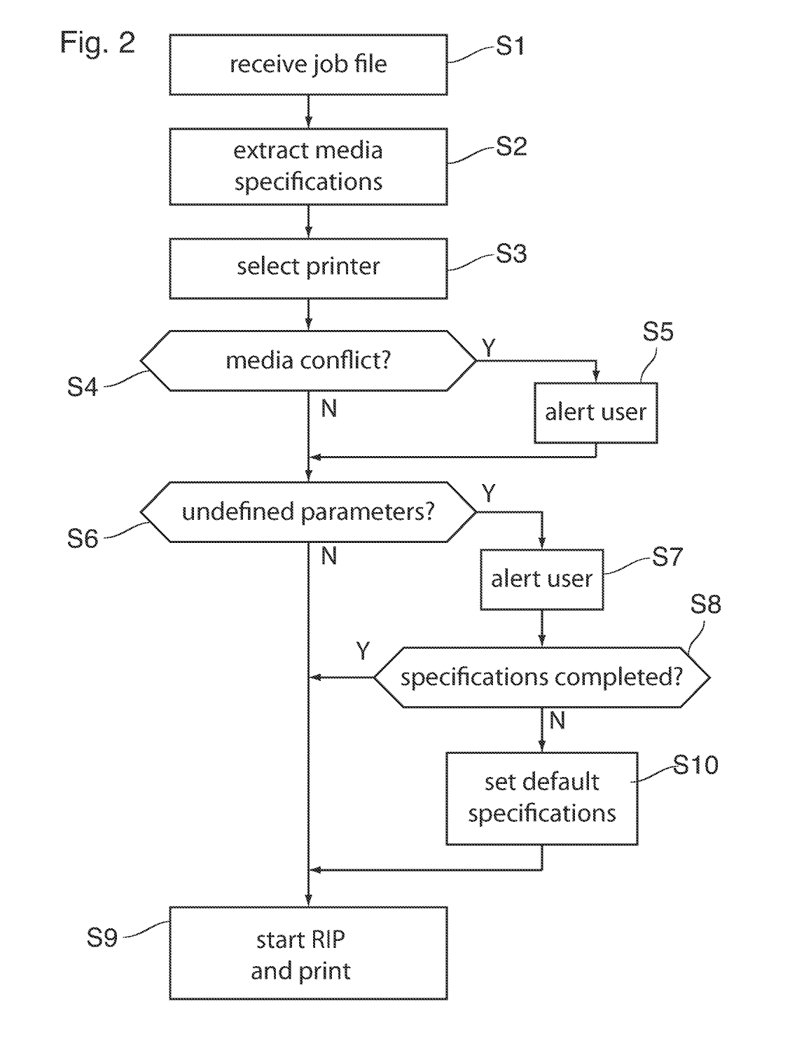

An example of a process flow has been illustrated in FIG. 2.

In step S1, a print job file is received at the receiving section 12. In step S2, the job file interpreter 26 extracts the media specifications which will then transmitted to the scheduler 22 which selects a suitable printer in step S3. In step S4, the media management system 28 checks whether there is any conflict between the media specifications and the properties and current status of the printer that has been selected for printing. In case of a conflict (Y), the user is alerted via the user interface in step S5.

If there is no conflict or at least no conflict that cannot resolved by selecting another printer (N), the management system 28 checks in step S6 whether the media specifications leave any relevant media parameters undefined. In this context “relevant media parameters” are parameters that have to be known in order to assure an optimal processing of the print job in the selected printer.

If there are any undefined parameters (Y), the user is alerted via the user interface in step S7. The alert will include a message identifying the missing parameters and inviting the user to enter these parameters. However, since the user may not know which parameters to enter, he is also given the option to rely upon default settings that have been determined in advance in the media management system or, as yet another option, to abort the print job altogether.

In step S8, it is checked whether the user has inserted the undefined parameters (Y) or not (N).

If all missing parameters have been inserted, raster image processing and printing is started on the basis of the completed set of parameters in step S9. If the user has decided in step S8 to continue with the default settings (N), the default specifications for the undefined parameters are set in step S10 before RIP and are printing started in step S9.

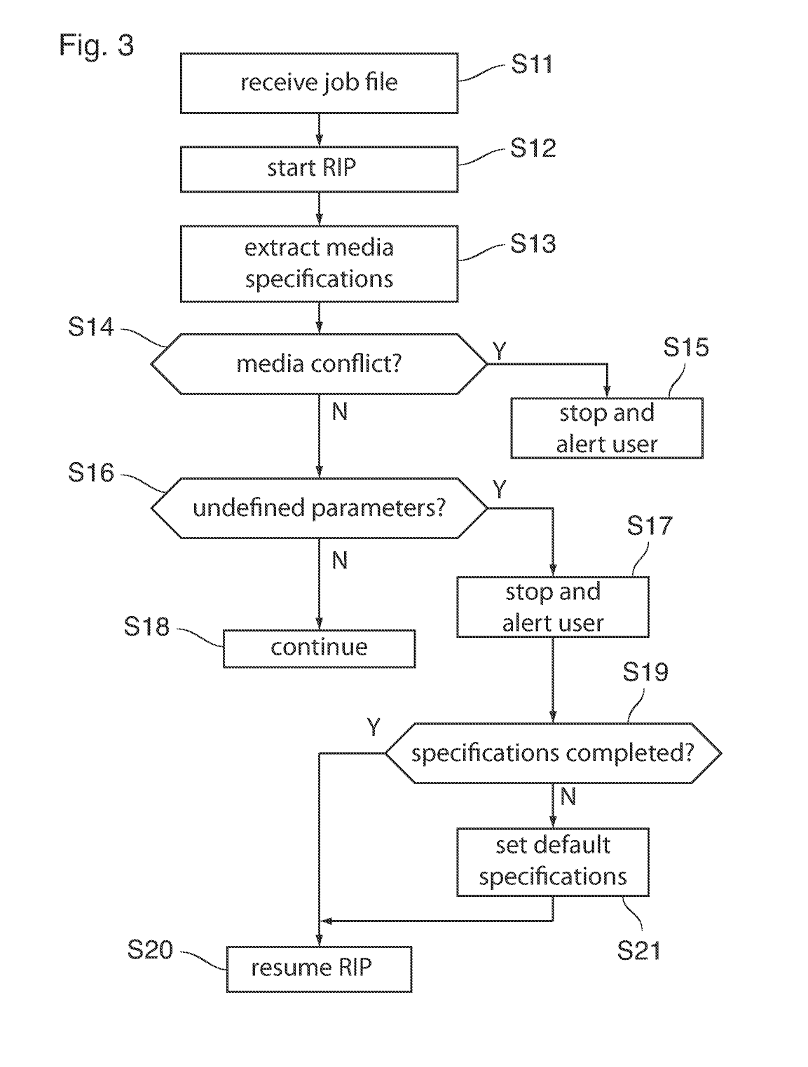

FIG. 3 illustrates a modified process flow. In this example, it is assumed that the printing system includes only a single printer, and the extraction of the media specifications forms part of the RIP.

The job file is received in step S11, and RIP is started in step S12. The RIP process for each individual page to be printed includes a step S13 of extracting the media specifications for that page.

Then, a check for media conflict is made in step S14, and if a conflict is found (Y), the RIP process is stopped and the user is alerted in step S15. If the print process has started already and reaches the page for which the conflict has been found, the print process will be put on hold as well.

If there is no media conflict (N) in step S14, the check for undefined media parameters is made in step S16. If there are any undefined parameters (Y), RIP processing (and possibly printing) are stopped and the user is alerted in step S17.

If no undefined parameters have been found in step S16 (N), the RIP processing (and possibly printing) are continued in step S18.

When the user has been alerted in step S17, it is checked in step S19 whether the user has inserted the missing parameters. If that is the case (Y), the RIP processing is resumed in step S20. In some cases, the parameters that have been specified by the user in step S19 may have an impact on the RIP processing. Then, if parts of the page to which the new parameters apply have been ripped already, it may be necessary to repeat the RIP process for that page.

If, in step S19, the user has chosen to rely upon the default settings (N), the default specifications for the formerly undefined parameters are set in step S21 before the RIP is resumed in step S20.

In a modified example, the RIP may not be stopped in step S17 but may instead be continued with the default settings. (It is preferable however to stop printing when a page is reached that has been ripped on the basis of the default parameters.) Then, if the specifications are changed in step S19, it will be necessary to discard the RIP results that have been obtained on the basis of the default settings. On the other hand, if the default settings are confirmed in steps S19 and S21, the RIP may continue without time loss.

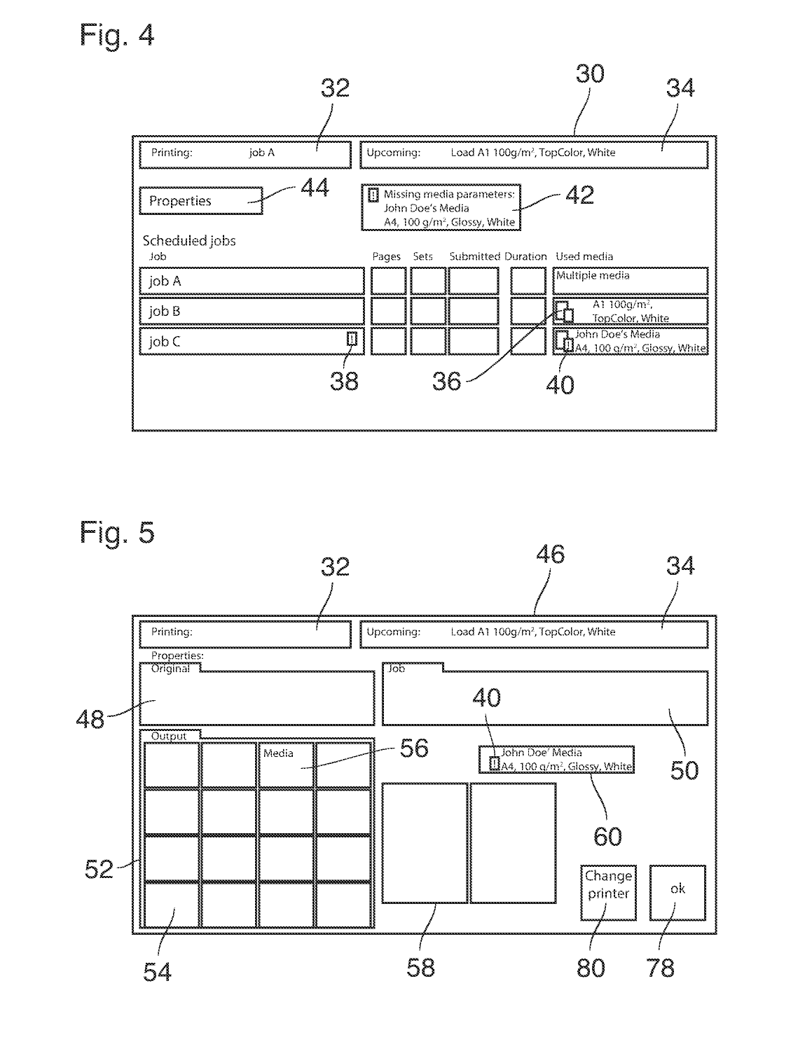

FIG. 4 is a simplified example of a screen 30 to be displayed on a display device of the user interface 24 (or the workstation 18) for advising the user or an operator of the current status of the print processing and of any actions that possibly need to be taken.

A field 32 in the top left corner indicates the job (“job A”) that is currently been printed. In the top right corner, a field 34 advises the user or operator of an upcoming action that is going to be required next. In this example, the required action is to load a supply of media sheets in the format A1 with a weight of 100 g/m², the material of the media sheets (or the media catalogue to which they belong) being “TopColor”, and the color being “White”.

In the lower part of the screen 30, below a headline “Scheduled jobs” there is a table listing all jobs (job A, job B, and job C in this example) that are scheduled for printing in the sequence in which they will be printed. Other columns of this table indicate for each job the number of pages it includes, the number of sets to be printed, the time at which the job was submitted, the expected duration of the print process and, what is of interest here, the media to be used for printing that job. In the second line of the table, i.e. the line for “job B”, in the column “Used media”, an icon 36 indicates that the media that are needed for that job are not presently available in the printer and need to be loaded—in accordance with the announcement in the field 34.

In the last line of the table (job C), an alarm symbol 38 in the leftmost column indicates that this job requires attention of the user or operator. Another alarm symbol 40 in the column “Used media” indicates that it is particularly the media specification that needs attention. A text in the field that includes the symbol 40 indicates some of the media parameters for that job, which means that the media specifications are not missing completely. Parameters, such as the media catalogue (“John Doe's Media”), the format (A4), the weight (100 g/m²) the surface finish (Glossy) and the color (White) have been specified. Nevertheless, some media parameters that are needed for optimal processing are missing. This message is also communicated in a pop-up window 42. Thus, by means of the symbols 38 and 40 and the pop-up window 42 the media management system 28 alerts the user that at least one relevant media parameter for job C is missing. More detailed information can be obtained by selecting job C and clicking on a button 44 “properties” in the screen 30.

Clicking this button 44 causes another screen 46 to be displayed, as has been shown in FIG. 5. Next to the windows 32 and 34 that have been discussed already, the screen 46 includes windows 48 and 50 communicating more specific properties of the original document from which copies are to be printed and other properties of the print job, as is commonly known in the art.

Another window 52 includes a number of tiles 54 that specify the usual job settings for the desired output, such as parameters specifying a zoon factor, simplex or duplex copies, stapling or non-stapling, and the like. One of these tiles, designated as 56, indicates the media specifications as included in the job file or inferred from the media catalogue that has been indicated in the job file.

The screen 46 further includes thumb-nails 58 of the first pages of the job as well as another pop-up window 60 that is a copy of the field from the screen 30 (FIG. 4) that includes the alarm symbol 40 and the available media parameters, indicating that it is the tile 56 “Media” that needs particular attention.

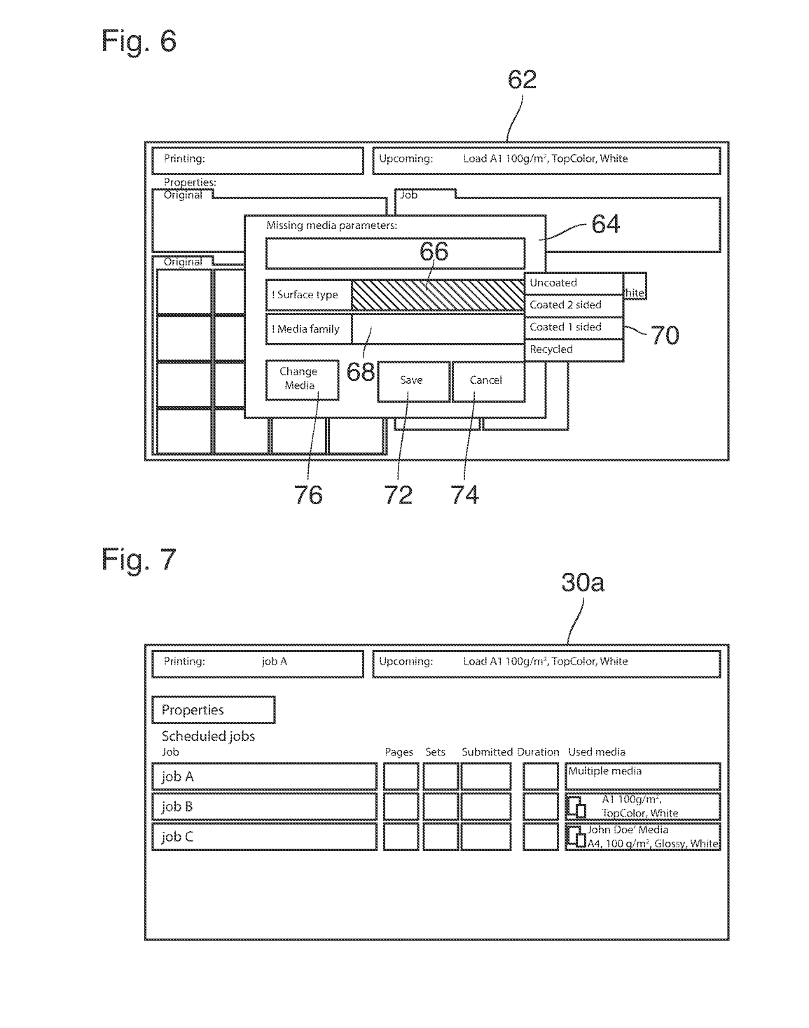

By clicking on the tile 56, the user can call up another screen 62 that has been shown in FIG. 6. This screen 62 is identical with the screen 46 except that it shows another pop-up window 64 that identifies the missing media parameters. In this example, there are two parameters missing, i.e. the Surface type and the Media family.

The window 64 includes fields 66 and 68 where the user may enter the missing parameters. In the example shown, the field 66 for the surface type has been activated (symbolized by hatching), with the result that a menu 70 has popped-up to indicate the available options for the field 66. In this way, the user is invited to complete the media specifications.

By clicking a button 72 “Save”, the entries in the fields 66 and 68 will be saved as the new media parameters. If a field has been left empty, the default settings will automatically be entered into that field.

As an alternative, the user may choose to press a button 74 “Cancel” in order to return to the screen 46, or to press a button 76 “Change Media” in order to edit the media specifications in the tile 56 (FIG. 5) i.e. to change to a completely different type of media, e.g. media for which all necessary parameters are available.

FIG. 7 shows a screen 30a which is a modified version of the screen 30 (FIG. 4), illustrating the appearance of the screen after the missing parameters have been entered. The alarm symbols 38 and 40 and the pop-up window 42 have disappeared. The RIP and print process will automatically be continued or resumed with the amended parameters.

On the other hand, if the user does not want to change the parameters but wants to continue with the default settings, he may press a button 78 “ok” in the screen 46 shown in FIG. 5.

In the embodiment shown in FIG. 1, the screen 46 may also offer an option to change to another printer in which the missing parameters are not needed or less critical, by clicking on a button 80 “Change printer”.

1. A print job processing system comprising:
a printer;
a user interface;
a job file receiving section; and
a media management system adapted to extract media specifications from a received job file and check the media specifications for compatibility with properties and/or a current status of the printer,
wherein the media management system is adapted to check whether essential media specifications are defined in the job file or not and, when they are not defined, to invite the user via the user interface to complete the specifications.

2. The system according to claim 1, wherein the media management system is adapted to offer, when essential media specifications are not defined, an option to adopt default settings for these specifications.

3. The system according to claim 1, configured to start raster image processing of the data to be printed before the extraction of the media specifications is completed and to stop raster image processing when it is found that essential media specifications are not defined.

4. The system according to claim 1, configured to start raster image processing of the data to be printed before the extraction of the media specifications is completed and, when it is found that essential media specifications are not defined, to continue with raster image processing on the basis of default settings until the user defines the missing specifications upon alert.

5. The system according to claim 1, configured to extract the media specifications from a received job file and only then to start raster image processing of the data to be printed.

6. A method of print job processing, comprising the steps of:
receiving a print job;
extracting media specifications from the print job; and
checking the media specifications for compatibility with properties and/or a current status of a printer to be used for printing,
wherein by a step of checking whether essential media specifications are defined in the job file or not, when they are not defined, inviting a user to complete the specifications.

7. The method according to claim 6, wherein the step of extracting media specifications is included in a step of raster image processing, and raster image processing is interrupted when undefined media specifications have been found.

8. The method according to claim 6, wherein the step of extracting media specifications is included in a step of raster image processing, and, when undefined media specifications have been found, raster image processing is continued on the basis of default settings until the user completes the undefined specifications.

9. The method according to claim 6, wherein the media specifications are extracted from the print file before raster image processing of the image data to be printed is started.

10. A software product embodied on a non-transitory computer readable medium and including program code that, when run on a controller of a printer, causes the controller to perform the method according to claim 6.
